(19) United States
(12) Patent Application Publication
(10) Pub. No.: US 2009/0207582 A1
(43) Pub. Date: Aug. 20, 2009

(54) Halloween Glowstick

(75) Inventors: Robert L. Dorsey, Cleveland, OH (US); Patrick Coyne, Cleveland, OH (US)

Correspondence Address: PATENT, COPYRIGHT & TRADEMARK LAW GROUP, 4199 Kinross Lakes Parkway, Suite 275, RICHFIELD, OH, 44286, US

(73) Assignee: Nottingham-Spirk Design Associates

(21) Appl. No.: 12/032,925

(22) Filed: Feb. 18, 2008

(51) Int. Cl. F21K 2/06

(52) U.S. Cl. 362/34

(57) ABSTRACT

A Halloween safety light glowstick having a symbolic long bone shape comprising a hollow shaft body that encases a glass ampule containing a chemiluminescent substance. A light is produced when the ampule ruptures in response to a bending of the plastic shaft body. Two locking arms that outline an articular joint member of a bone lockingly engage the glowstick to a costume. The articular joint member comprises a plug component that can be removed from the shaft body to provide access to the interior and to connect the shaft body to others, essentially extending a length of the lit body portion. The instant abstract is neither intended to define the invention disclosed in this specification nor intended to limit the scope of the invention in any way.

### BACKGROUND OF THE INVENTION

1. Field of the Invention

The present invention relates generally to a glowstick and, more specifically, to a safety glowstick of an unlimited length that clips to the costume attire of trick-or-treaters.

2. Description of the Related Art

Ancient Celts noticed that every year in late October plants died, animals disappeared, days grew shorter and nights grew longer. Fearing total darkness and mischievous spirits, the Celts believed that they could quell evil spirits with bon fires, or “bonefires”, kindled from the dried skeletons of sacrificed animals. Heads of households carried to their homes a coal from these bonefires in lanterns of carved turnips. They used the lanterns to guide and to welcome family spirits. They wore costumes to fool the evil spirits.

Halloween has a history rich in superstition, but its now celebrated once a year for entertainment. Bones are very symbolic of Halloween tradition because they weren't only used to burn effigies; they were collected and read to predict the next year's fortunes. For this reason, bone-shaped decorations, toys, candies and pastries are prepared for present-day festivities.

The greatest of all festivities is trick-or-treating by costumed children. Because these children comb yards and neighborhoods for the most candies possible, there is a need for apparatuses that ensure their safety. The present invention is a safety apparatus shaped like the symbolic Halloween bone. It is an improved glow stick that can be worn by trick-or-treaters to make them visible to oncoming traffic.

### SUMMARY OF THE INVENTION

It is an object of the present invention to provide a Halloween safety light decoration in the form of a glow stick that can be attached to the attire of trick-or-treaters. It is an object that the present glow stick illuminate when bent. It is an object that the illumination makes the trick-or-treaters visible to oncoming traffic.

It is an object that the body of the present glow stick comprises a plastic capable of moderate bending such that a glass ampule can be cracked inside. It is an object that the body is at least translucent such that the light emitted from the glow stick can be seen from approaching persons and vehicles.

It is an object that the present body is a hollow body that comprises the closed glass ampule in its interior portion. It is an object that the glass ampule contains a chemiluminescent substance in a deactivated state. It is envisioned that a bend of the plastic body causes the glass ampule to break, wherein a chemical reaction is induced from the chemiluminescent substance. The reaction produces a light that causes the present bone to glow.

It is an object that the present invention is shaped like a long bone having a long-shaft body and two articular joint surfaces. The shaft body can approximate a cylindrical shape that comprises at least one open distal end. It is an object that the both of the articular joint surfaces can be removed such that an unlimited number of shaft bodies can be connected to create a longer illuminated body. It is further an object that the articular joint surfaces can removably attach to the shaft body such that replacement glass ampules can be placed in the reusable shaft body interior.

It is an object that the foregoing is accomplished by means of a first distal end capable of mating with the opposing distal end of another shaft body. It is therefore envisioned that each long shaft comprises two nonidentical distal ends: a first, male end capable of receiving the female end of another shaft body; and, a second, female end capable of plugging into a first end on another shaft body.

It is a further object that each articulate joint section is capable of attaching to an attire of trick-or-treaters. It is envisioned that this means of attachment is by way of a clip.

It is a final object to provide all of the benefits that the foregoing objects entail.

### BRIEF DESCRIPTION OF THE DRAWINGS

The advantages and the features of the present invention are better understood with reference to the following and the more detailed description and the claims taken in conjunction with the accompanying drawings, in which like elements are identified with like symbols, and in which:

FIG. 1 is a Halloween safety light glow stick according to a preferred embodiment of the present invention, wherein a glass ampule is contained in a hollow shaft body interior;

FIG. 2 is a shaft body of the glow stick shown in FIG. 1;

FIG. 3 is the glow stick of FIG. 1, wherein the glass ampule breaks to activate when the glow stick is bent;

FIG. 4 is a glow stick without a glass ampule contained therein, wherein a removable articulate joint member provides access to the interior; and,

FIG. 5 is the glowstick of FIGS. 1-4, wherein the articulate joint member comprises an attachment device to clip to attire.

### DETAILED DESCRIPTION OF THE PREFERRED EMBODIMENT

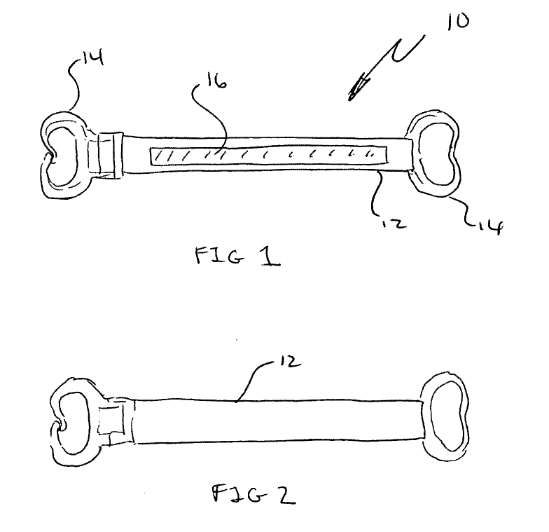

FIGS. 1 to 5 show a Halloween safety light glowstick 10 (hereinafter “glowstick”) according to a preferred embodiment of the present invention. The glowstick 10 is shaped like a symbolic Halloween bone, but it may take a form of many other holiday symbols to accomplish the same functions taught herein. The glowstick 10 shown in the figures resembles a long bone comprising a hollow shaft body 12 (shown in FIG. 2) and two articular joint surface outlines 14.

A glass ampule 16 is encased in the hollow shaft body 12 interior. The glass ampule contains a chemiluminescent substance in a deactivated state. The chemiluminescent substance is the same as that well known in the art for standard glowsticks. The glass ampule 16 cracks when the glowstick 10 is bent. This crack exposes the chemiluminescent substance to the air, wherein a chemical reaction causes the substance to give off an illumination effect.

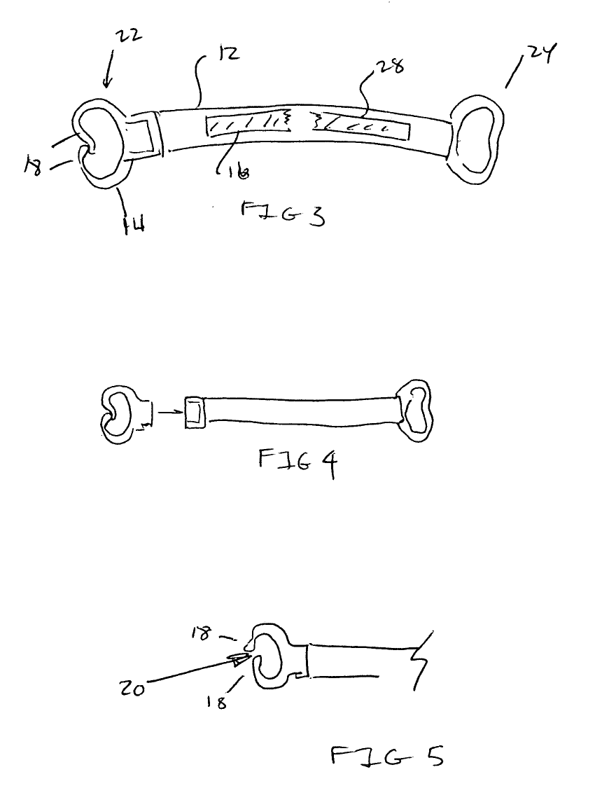

It is preferred that the hollow shaft body 12 be manufactured from a plastic capable of moderate bending (shown in FIG. 3) such that the glass ampule 16 can be cracked, but that the plastic is resilient too such that it retains the cylindrical shape immediately after it is slightly bent. It is also preferred that the plastic be clear or translucent so that the light created by the chemiluminescent substance can be effectively emitted from the glowstick 10 body.

The shaft body 12 can approximate a cylindrical shape that is open for at least one of its two distal ends. FIG. 4 shows the glowstick 10 without a glass ampule 16 contained therein, wherein an articulate joint member 14 provides access to the interior. At least one of both of the articular joint surfaces 14 removably attach to the shaft body 12 such that replacement glass ampules 16 can be placed in an interior of the reusable body.

The articular joint surfaces 14 are more clearly shown in FIG. 5. They essentially comprise only an outline of that same surface for natural bone, but the centers are open. At least one of the joint surfaces 14 provides a means to fasten the glowstick 10 to a person and, namely, to a child trick-or-treater. Any means known in the art to attach articles to attire can be utilized, s.a., a clip, a pin, etc.; however, the means to comprise the preferred embodiment is shown in FIG. 5. Essentially, the joint surface 14 is two locking arms 18 that lockingly engage one another by means of a catch release 20.

An advantage to the present invention is that two or more shaft bodies 12 can be connected to form a glowstick 10 of unlimited length. The present glow stick 10 comprises a shaft body 12 that is capable of removably attaching itself to a second shaft body. This capability is firstly accomplished by manufacturing a body 12 that slightly tapers such that a first distal end 22 comprises a minimally larger circumference than that of an opposing distal end 24. The capability is secondly accomplished by means of a short channel 26 that extends out of the first distal end 22 such that it can matingly receive the second distal end 22 of another shaft body. Therefore, the second distal ends 24 of shaft bodies 12 are capable of plugging into the channels 26 formed on opposing ends of different bodies.

In the same manner, at least one of the joint surfaces 14 plug into or receive the distal ends 24, 24 of the shaft body(ies) 12 (as shown in FIG. 4). The joint surface 14 shown in FIG. 4 removes from the channel 26 to provide an access to the interior of the shaft body 12. Therefore, a user can empty the broken ampule 28 contents therein and place a new glass ampule 16 in the interior such that the glowstick 10 can be reused for many consecutive Halloweens.

The present invention provides a Halloween safety light decoration in the form of a glowstick 10 that can be attached to the attire of trick-or-treaters, wherein the illumination makes the trick-or-treaters visible to oncoming traffic.

It is anticipated that the joint surface components can be replaced with other end caps that comprise various seasonal themes, such that the present invention can be utilized for all holidays year round.

### OPERATION OF THE PREFERRED EMBODIMENT

To utilize the present invention, a plug that appears to resemble the joint surface of a natural long bone is pulled from a channel comprised at the distal end of the long shaft to expose its hollow, interior portion. A glass ampule comprising a chemiluminescent substance is placed in the interior and the joint surface plug is reinserted in the channel to securely encase it therein. The shaft body of the bone-shaped safety light decoration is bent to rupture the glass ampule. The reaction induced by the chemiluminescent substance contained in the ampule produces a light that transmits through the plastic shaft body. The glowstick is than capable of attaching to the costume attire of a trick-or-treater by means of the catch release comprised at the ends of the locking arms that make up the joint surface component. A push of the two locking arms towards one another releases the locking engagement such that the used ampule can be emptied and the glowstick can be reused the next Halloween.

The foregoing descriptions of specific embodiments of the present invention have been presented for the purposes of illustration and description. They are neither intended to be exhaustive nor to limit the invention to the precise forms disclosed, and obviously, many modifications and variations are possible in light of the above teaching. The embodiments were chosen and described in order to best explain the principles of the invention and its practical application, to thereby enable others skilled in the art to best utilize the invention and its various embodiments with various modifications as are suited to the particular use contemplated. It is intended that the scope of the invention be defined most broadly by the specifications and the figures appended hereto and their equivalents. Therefore, the scope of the invention is to not to be limited by the following claims.

Having thus described the invention what is claimed as new and desired to be secured by Letters Patent is as follows:

1. A Halloween safety light glowstick having a symbolic long bone shape, said glowstick comprises:
a hollow shaft body;
a glass ampule contained in said shaft body;
two articular joint surface components comprised at the distal ends of said shaft body;
wherein said glass ampule contains a chemiluminescent substance in a deactivated state such that a bend of said shaft body causes said glass ampule to rupture, said rupture causes a reaction of said chemiluminescent substance which provides light.

2. The glowstick of claim 1, wherein said shaft body is manufactured from an at least translucent and resilient plastic capable of moderate bending, said plastic is flexible enough to tolerate a bend necessary to rupture said glass ampule.

3. The glowstick of claim 1, wherein said shaft body approximates a cylindrical shape having at least one open distal end.

4. The glowstick of claim 1, wherein at least one of both of said articular joint components removably attach to said shaft body such that replacement glass ampules can be placed in an interior of said shaft body.

5. The glowstick of claim 1, wherein said articular joint components comprise two locking arms that outline an articular joint member on a natural bone, said two locking arms lockingly engage one another by means of a catch release.

6. The glowstick of claim 1, further comprising a short channel that extends out of a first distal end of said shaft body.

7. The glowstick of claim 7, wherein said shaft body slightly tapers such that a first distal end comprises a minimally larger circumference than that of an opposing distal end.

8. The glowstick of claim 7, wherein at least one of said joint surface components is a removable plug that is received in said channel.
